(19) United States
(12) Patent Application Publication
(10) Pub. No.: US 2013/0302041 A1
(43) Pub. Date: Nov. 14, 2013

(54) OPTICAL RECEIVER AND METHOD FOR OPTICAL RECEPTION

(71) Applicants: Junichiro Matsui, Tokyo (JP); Junichi Abe, Tokyo (JP); Daisaku Ogasahara, Tokyo (JP)

(72) Inventors: Junichiro Matsui, Tokyo (JP); Junichi Abe, Tokyo (JP); Daisaku Ogasahara, Tokyo (JP)

(73) Assignee: NEC CORPORATION, Tokyo (JP)

(21) Appl. No.: 13/981,209

(22) PCT Filed: Feb. 1, 2012
(86) PCT No.: PCT/JP2012/052792

§ 371 Date: Jul. 23, 2013

(30) Foreign Application Priority Data
Feb. 2, 2011 (JP) 2011-020707

(51) Int. Cl. H04B 10/61

(52) U.S. Cl. CPC H04B 10/6161
USPC 398/208

(57) ABSTRACT

In order to improve degradation of receiving sensitivity caused by analog characteristics degradation in an optical receiver, the optical receiver includes: the first coefficient computing unit for computing the first equalization filter coefficient for compensating the first waveform distortion caused and formed by an optical transmission path; the second coefficient calculating unit for predetermining the second equalization filter coefficient for compensating the second waveform distortion caused and formed by an analog characteristics degradation of components; a coefficient operating unit for performing operation to the first equalization filter coefficient and the second equalization filter coefficient and outputting the third equalization filter coefficient; and a waveform equalization processing unit including a waveform equalization filter for performing an equalization process to an input signal including the first waveform distortion and the second waveform distortion based on the third equalization filter coefficient, correcting each of the first waveform distortion and the second waveform distortion and outputting an output signal.

### TECHNICAL FIELD

The present invention relates to an optical receiver and a method for optical reception, and in particular relates to the optical receiver and the method for optical reception to which a digital coherent optical receiving method is applied.

### BACKGROUND ART

In recent years, in accordance with an increase of optical transmission capacity and speed, reduction in a device cost and improvement of signal transmission efficiency are progressed for an optical receiver used for an optical fiber communication system by applying a digital coherent optical receiving method. In the digital coherent optical receiving method, in order to receive information superimposed on amplitudes and phases in an optical electric-field, the method mixes a received light with a local oscillation light (local emitting light) having a light frequency almost equals to that one, detects with a photo detector an interference light which occurs by the mixture and converts into an electric signal.

The optical receiver to which the digital coherent optical receiving method is applied performs a coherent reception of the optical signal and converts the optical signal into an electric signal, and then performs a waveform equalization process or the like including compensation of chromatic dispersion by a digital signal process. In other words, for the digital coherent optical reception, because information included in both amplitudes and phases of the optical electric-field of the received light signal can be obtained as an electric signal, highly accurate compensation of the waveform distortion is enabled by using electric equalization filters. Therefore, the optical receiver to which the digital coherent optical receiving method is applied does not require an expensive dispersion compensation fiber, and can achieve substantial cost reduction.

An outline of the optical receiver to which the digital coherent optical receiving method is applied will be described.

FIG. 1 is a block diagram showing an exemplary configuration of the optical receiver to which the digital coherent optical receiving method is applied.

This optical receiver 1, as an example, performs the coherent reception of the optical signal for an input optical signal which is performed a polarization multiplexed with multi-level phase shift modulation.

The optical signal propagated through an optical fiber transmission path not illustrated is inputted to a polarization beam splitter 11 of the optical receiver. The polarization beam splitter 11 separates an inputted optical signal into a polarization of X component and a polarization of Y component and outputs the optical signals to respective optical hybrid circuits. For example, X component is outputted to an optical hybrid circuit 21, and Y component is outputted to an optical hybrid circuit 22.

In addition, a local emitting light which is outputted from a local oscillation light source 60 is also separated by a polarization beam splitter 12 into a polarization of X component and Y component, and are outputted to the optical hybrid circuit corresponding to the separated local oscillation light. In this case, in the same manner as the optical signal, X component is output to the optical hybrid circuit 21 and Y component is output to the optical hybrid circuit 22.

Each of the optical hybrid circuits 21 and 22 mix the inputted optical signal with the local emitting light, and output two sets of light in which phase are different in 90 degrees each other. Two sets of light means a light of I-component (i.e. In-phase: common phase) and a light of Q-component (i.e. Quadrature: quadrature phase).

These lights of the light of I-component and the light of Q-component are inputted to respective O/E (Optical/Electrical) conversion units. The O/E conversion unit photo-electrically converts the inputted light and outputs the photo-electrically converted signal as an analog electric signal in which an appropriate gain adjustment or the like are performed. Then, the analog electric signal is inputted to an A/D (Analog/Digital) conversion unit, sampled in an appropriate time interval and converted into a quantized digital signal.

It is clear from FIG. 1 that, in the optical receiver 1, the light of I-component outputted from the optical hybrid circuit 21 which handles component X of the polarization is processed by an O/E conversion unit 31a and an A/D conversion unit 41a. In addition, the light of Q-component outputted from the optical hybrid circuit 21 is processed by an O/E conversion unit 31b and an A/D conversion unit 41b. Similarly, the light of I-component outputted from the optical hybrid circuit 22 which handles component Y of the polarization is processed by an O/E conversion unit 32a and an A/D conversion unit 42a. Further, the light of Q-component outputted from the optical hybrid circuit 22 is processed by an O/E conversion unit 32b and an A/D conversion unit 42b.

Because of chromatic dispersion inherent in the optical fiber and a polarization mode dispersion caused by stresses or the like added to the optical fiber, waveform degradations occur to the optical signal while the optical signal transmits the optical fiber transmission path. Therefore, the digital signal outputted from each A/D conversion unit is inputted to a digital signal processing unit 50, and the various waveform equalization processes are performed, recovered as an original data signal and outputted. Where, in the digital signal processing unit 50, the waveform equalization process is performed to each of the components of XI, XQ, YI and YQ. Usually, as a method of correcting the waveform degradations due to these dispersion, a waveform equalization using a FIR (Finite Impulse Response) digital filter having a finite impulse response characteristic is applied.

FIG. 2 is a block diagram showing an exemplary configuration of the digital signal processing unit 50 in FIG. 1. The digital signal processing unit 50 corrects both the dispersion and phase rotations generated while the optical signal is transmitted in the optical fiber transmission path and a frequency offset caused by a frequency difference between the optical signal and the local oscillation light source 60. The original data signal recovered by the digital signal processing unit 50 is outputted to framer circuits and forward error correcting circuits connected at a latter stage of the optical receiver 1.

The digital signal processing unit 50 includes a chromatic dispersion compensating unit 51, a polarization mode dispersion compensating unit 52, a frequency/phase compensating unit 53 and a signal identifying unit 54.

The chromatic dispersion compensating unit 51 corrects a waveform distortion caused by the chromatic dispersion. The chromatic dispersion is a phenomenon in which a spectral bandwidth of the optical signals spreads, and is caused by a difference of transmitting velocity of light in a medium depending on the wavelengths. The chromatic dispersion closely relates to materials of the optical fiber, structures and a transmission distance. For this reason, the spread of waveform caused and occurred by the chromatic dispersion will be almost fixed.

The polarization mode dispersion compensating unit 52 corrects the waveform distortion due to the polarization mode dispersion caused by the polarization. The polarization mode dispersion is a phenomenon in which a group delay difference is caused between the two polarization modes crossing at right angles because of a minute birefringence of a single mode fiber. Because the polarization mode dispersion is caused by stresses added to the optical fiber, the waveform distortion caused and occurred includes a time-wise high-speed fluctuation. Therefore, an adaptive equalization filter in which coefficients are updated periodically so that they will be most suitable values is normally applied.

The frequency/phase compensating unit 53 corrects a phase rotation of the polarized wave, and a frequency difference between the optical signal and a local oscillation light source. The phase rotation and the frequency difference also involve a high-speed fluctuation in terms of time, and the adaptive equalization filter is normally applied.

The signal identifying unit 54 determines whether or not the digital signal processed and outputted by the chromatic dispersion compensating unit 51, the polarization mode dispersion compensating unit 52 and the frequency/phase compensating unit 53 is a data signal of either logic 0 or 1, and outputs the determination result.

The patent literatures 1 to 3 disclose technologies in relation to these kinds of digital coherent optical reception.

For example, the patent literature 1 discloses a technology of enhancing an accuracy of a digital processing circuit used in a digital coherent optical receiving device. The technology disclosed in the patent literature 1 uses a sampling clock from a clock signal of a free-running clock oscillator as a clock for a digital conversion instead of recovering from an optical signal. The patent literature 1 discloses a configuration of the digital coherent optical receiving device as follows.

A local oscillator, a 90-degrees phase hybrid circuit and an optical-electrical conversion element convert a received optical signal into an electric signal which indicates a complex electric field of the optical signal. A free-running sampling trigger source oscillates a clock signal at a frequency set in advance based on frequency of the optical signal. ADC (Analog/Digital Converter) converts the electric signal converted by the local oscillator, the 90-phases hybrid circuit and the optical-electric conversion element into a digital signal. Specifically, the ADC performs the digital conversion by sampling the electric signal at the frequency of the clock signal oscillated in the free-running sampling trigger source. A demodulation unit demodulates the digital signal converted by the ADC.

In addition, the patent literature 2 discloses a distortion compensator capable of performing nonlinear distortion compensation in a digital coherent optical receiving device with high degree of accuracy to an electric signal obtained by optically-electrically converting the optical signal received from an optical transmission path. This distortion compensator has a function of compensating a nonlinear distortion by a self-phase modulation. The self-phase modulation is a nonlinear distortion generated when a phase is modulated at the time when an optical signal power in the optical fiber becomes large. In an actual optical transmission system, a linear effect and a nonlinear effect are generated simultaneously or alternatively. For this reason, by a method of performing the nonlinear distortion compensation after performing the linear distortion compensation altogether to a plurality of transmission spans, the distortion compensation, in particular the nonlinear distortion compensation, cannot be performed with high accuracy. A distortion compensator disclosed in the patent literature 2 includes a multiple stages distortion compensating unit which is a cascaded connection of a plurality of distortion compensating units equipped with the linear distortion compensating unit for compensating the linear waveform distortion of the optical signal and a nonlinear distortion compensating unit for compensating the nonlinear waveform distortion of the optical signal. Then, the linear distortion compensating units and the nonlinear distortion compensating units are combined so that the distortion compensation of the multiple stages distortion compensating unit will be optimal.

The patent literature 3 discloses a digital coherent optical reception device which can be applied to a plurality of bit rates (e.g. 10 Gbps and 40 Gbps). The digital coherent optical reception device disclosed by the patent literature 3 includes first and second converting means, parallel number changing means and signal processing means. The first converting means converts a received optical signal into an electric signal and outputs the electric signal, and the second converting means converts the electric signal into a parallel data signal and outputs the parallel data. The parallel number changing means changes a parallel number of the parallel data signal in accordance with bit rate of the optical signal and outputs the parallel data signal having the modified parallel numbers. The signal processing means demodulates the received signal based on the parallel data signal.

At that time, according to the bit rate, the parallel number changing means changes the parallel number (i.e. number of channels) of the digital signal so that each output signal will always have the same data rate. Accordingly, the parallel number of the output signal outputted from the parallel number changing means changes in accordance with the bit rate. For example, the parallel number becomes large in accordance with the bit rate becomes high, and the parallel number becomes small in accordance with the bit rate becomes low. However, number of physical signal lines does not change. This digital coherent optical reception device can adjust to a plurality of bit rates without changing the sampling frequency at the time of analog-to-digital conversion and without variably setting the data rate of the parallel data signal.

### PRIOR ART REFERENCE

### Patent Literature

Patent literature 1: Japanese Patent Application Laid-Open No. 2010-004245
Patent literature 2: Japanese Patent Application Laid-Open No. 2010-050578
Patent literature 3: Japanese Patent Application Laid-Open No. 2010-098617

### SUMMARY OF THE INVENTION

### Problem to be Solved by the Invention

The above-mentioned respective compensation units in a digital signal processing unit correct the waveform distortion caused by the chromatic dispersion and the polarization mode dispersion, and frequency difference of the optical signal and the local oscillation light source. However, for the optical receiver to which the digital coherent optical receiving method is applied, analog characteristics degradation factors are also included in addition to above-mentioned factors.

For example, a polarization beam splitter separates single polarization multiplexed phase modulated optical signal into X polarization component and Y polarization component. Then, the optical hybrid circuit further separates the respective polarization component of the optical signal into I-component and Q-component. As the result, one optical signal is separated by the polarization beam splitter and the optical hybrid circuit into four optical signals. However, due to used materials and manufacturing processes of those which configure the polarization beam splitter and the optical hybrid circuit, fluctuation of characteristics may occur to the optical waveguide which these four optical signals pass. Accordingly, in these kinds of cases, a fluctuation occurs to respective output timing of each one of four optical signals outputted from the optical hybrid circuit, and also delay time occurs between the optical signals. In addition, some polarization beam splitters or the optical hybrid circuits may have a characteristic that cannot be completely separated between X polarization component, and Y polarization component and between I-component and Q-component. In other words, the other component which should fundamentally be separated remains in a component. In addition, even for photodiodes and transimpedance amplifiers included in the O/E conversion unit, there are also non-uniformities on optical-electrical conversion gain and non-uniformities of gain to a control voltage caused by fluctuation of components and manufacturing. Moreover, in an A/D conversion unit, a band degradation in which the gain of a broadband signal component degrades while a process of converting the analog signal into the digital signal occurs.

In this way, when the analog characteristics degradation factors are included in the polarization beam splitter, the optical hybrid circuit, the O/E conversion unit and the A/D conversion unit, there is a possibility that desired correcting characteristics cannot be achieved in various compensation processes at a latter stage in the digital signal processing unit. As the result, there is a possibility that receiving sensitivity of the optical receiver may degrade.

Further, in all the above-mentioned patent literatures 1 to 3, the analog characteristics degradation factors provided in the optical receiver itself are not considered.

The object of the present invention is to provide an optical receiver and a method for optical reception which settle a problem of improving a degradation of receiving sensitivity caused by analog characteristics degradation in the optical receiver to which the digital coherent optical receiving method is applied.

### Means for Solving Problem

In order to achieve the above-mentioned purpose, an optical receiver according to an embodiment of the present invention is characterized by comprising a waveform equalization processing means which includes the first coefficient computing means for computing the first equalization filter coefficient for compensating the first waveform distortion which is caused and formed when a optical signal is transmitted in an optical fiber transmission path, the second coefficient setting means for predetermining the second equalization filter coefficient for compensating the second waveform distortion which is caused and formed by an analog characteristics degradation of components which configure the optical receiver, a coefficient operating means for performing operation on the first equalization filter coefficient and the second equalization filter coefficient and outputting the third equalization filter coefficient, and a waveform equalization filtering means for performing an equalization process to an input signal including the first waveform distortion and the second waveform distortion based on the third equalization filter coefficient, respectively correcting the first waveform distortion and the second waveform distortion and outputting an output signal.

In addition, a method for optical reception according to another embodiment of the present invention is characterized by computing the first equalization filter coefficient for compensating the first waveform distortion which is caused and formed when a optical signal is transmitted in an optical fiber transmission path, obtaining a predetermined second equalization filter coefficient for compensating the second waveform distortion which is caused and formed by an analog characteristics degradation of components which configure an optical receiver, performing operation on the first equalization filter coefficient and the second equalization filter coefficient and generating the third equalization filter coefficient, performing an equalization process to an input signal including the first waveform distortion and the second waveform distortion based on the third equalization filter coefficient, and outputting an output signal in that the first waveform distortion and the second waveform distortion are respectively corrected.

### Effect of the Invention

The present invention realizes an optical receiver capable of improving degradation of receiving sensitivity due to analog characteristics degradations in an optical receiver to which a digital coherent optical receiving method is applied.

### BRIEF DESCRIPTION OF DRAWINGS

FIG. 1 is a block diagram showing an exemplary configuration of an optical receiver to which a digital coherent optical receiving method is applied.

FIG. 2 is a block diagram showing an exemplary configuration of the digital signal processing unit 50 in FIG. 1.

FIG. 3 is a block diagram showing an exemplary configuration of a FIR filter.

FIG. 4 is a block diagram showing an exemplary configuration of a frequency domain waveform equalization filter.

FIG. 5 is a block diagram showing a configuration of a waveform equalization processing unit included in the optical receiver according to the first exemplary embodiment of the present invention.

FIG. 6 is a flow chart showing a process of the waveform equalization processing unit included in the optical receiver according to the first exemplary embodiment of the present invention.

FIG. 7 is a block diagram showing a configuration of a waveform equalization processing unit which is included in the optical receiver according to the second exemplary embodiment of the present invention.

FIG. 8 is a block diagram showing a configuration of the second coefficient setting unit in the variation example according to the second exemplary embodiment.

FIG. 9 is a block diagram showing a configuration of a waveform equalization processing unit included in the optical receiver according to the third exemplary embodiment of the present invention.

FIG. 10 is a block diagram showing a configuration of a digital signal processing unit included in the optical receiver according to the fourth exemplary embodiment of the present invention.

FIG. 11 is a block diagram showing a configuration of a waveform equalization processing unit which is a chromatic dispersion compensating and polarization mode dispersion compensating unit included in the digital signal processing unit of the optical receiver according to the fourth exemplary embodiment of the present invention.

### BEST MODE FOR CARRYING OUT THE INVENTION

An optical receiver according to the present invention is characterized by performing waveform equalization processes using filter coefficients which include coefficients for improving analog characteristics degradations in each signal compensation unit of the digital signal processing unit.

Normally, a FIR digital filter having a finite impulse response characteristic is applied to waveform equalization as a time domain equalization filter.

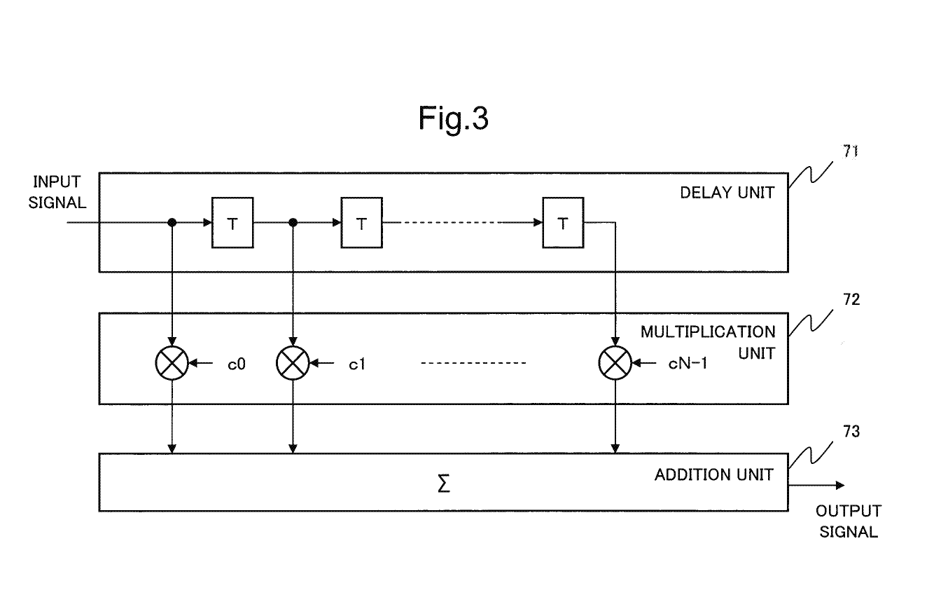

FIG. 3 is the block diagram showing an exemplary configuration of the FIR filter.

The FIR filter includes, for example, a delay unit 71 including a plurality of delay circuits connected in series, a multiplication unit 72 comprising a plurality of complex multipliers and an addition unit 73 consisting of a complex adder. Each delay circuit delays an inputted complex signal equals to a sampling time T and then outputs the delayed signal to a latter stage. In addition, each complex multiplier complex-multiplies a signal tapped before and after each delay circuit by a time domain equalization filter coefficient c0 to cN−1 corresponding to each tap, and then outputs the tapped signal to the addition unit 73 after the complex-multiplying. By taking a total sum of output of each complex multiplier by the complex adder, the addition unit 73 generates and outputs a signal performed the digital filter process with the coefficient c0 to cN−1 of the input signal.

Here, concerning the time domain equalization filter coefficient correspond to each tap, the coefficient required for the waveform equalization is adaptively calculated by using a technology of CMA (Constant Modulus Algorithm) or the like by monitoring the output signal. Where, descriptions on a coefficient computing algorithm such as CMA are skipped.

This time domain equalization filter is usually used for the compensation of the polarization mode dispersion.

In order to compensate the chromatic dispersion, the FIR filter having a quite many number of taps is needed, as described later, when the time domain equalization filter is used.

The chromatic dispersion of the optical fiber depends on materials of the fiber and the configuration. In addition, a spread of a waveform of a optical signal by the chromatic dispersion tends to increase in proportion with a distance. For example, amount of the chromatic dispersion will be approximately 20,000 ps/nm after transmitting in a distance of 1000 km. For example, when a 100 Gbps signal with interval of 50 GHz is transmitted by wavelength multiplexing, the spread of the waveform of the optical signal by the chromatic dispersion will be approximately 8,000 ps. In addition, when the 100 Gbps signal is transmitted by the polarization multiplexing with a optical signal of quadrature phase shift keying, symbol rate of a coherent received analog electric signal becomes 25 Gbps. Therefore, when sampling is performed by a double frequency which satisfies a sampling theorem at the time of A/D conversion, sample interval equals 20 ps. Accordingly, when the FIR filter is used for compensating the chromatic dispersion, a huge FIR filter having 400 taps is required in order to compensate the chromatic dispersion of 20,000 ps/nm.

Therefore, in order to compensate the chromatic dispersion, a frequency domain waveform equalization filter which can realize the characteristics equivalent to the multiple FIR filter with relatively small size of circuits is used.

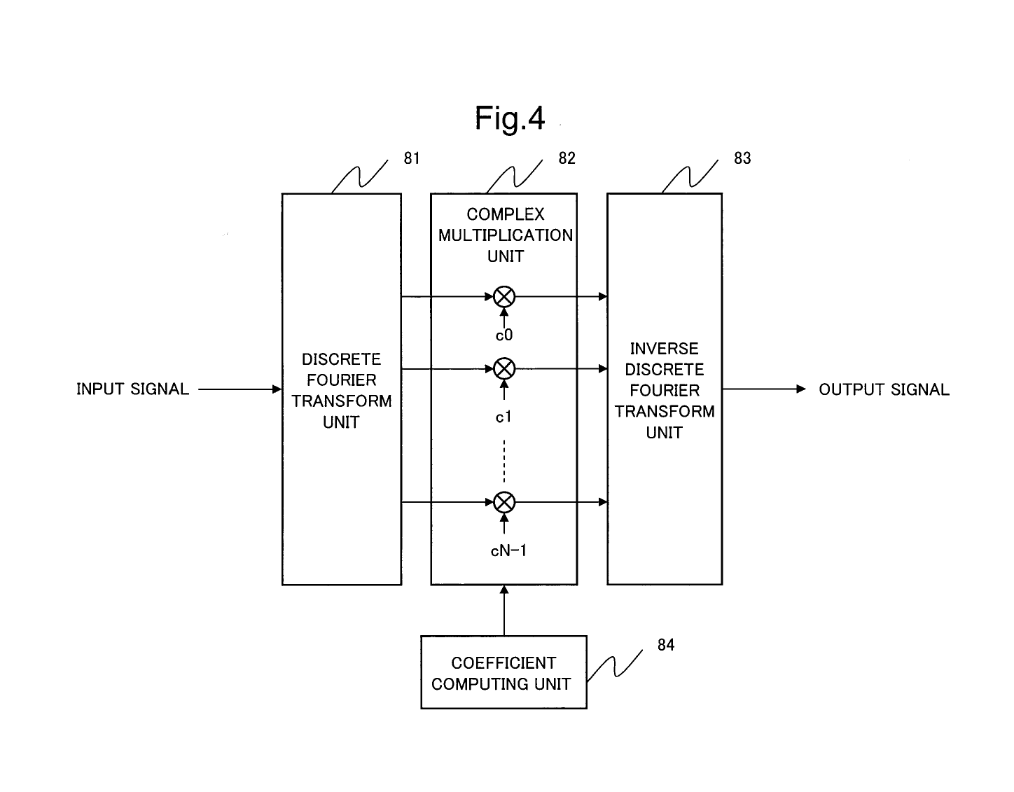

FIG. 4 is the block diagram showing the exemplary configuration of the frequency domain waveform equalization filter.

The frequency domain waveform equalization filter includes a discrete Fourier transform unit 81, a complex multiplication unit 82, an inverse discrete Fourier transform unit 83 and a coefficient computing unit 84.

The discrete Fourier transform unit 81 performs discrete Fourier transform to an inputted complex signal sampled and digitalized at a device in the former stage and converts the inputted complex signal into a complex signal in a frequency domain. In other words, by performing discrete Fourier transform to the inputted time domain signal, the discrete Fourier transform unit 81 obtains a signal in the frequency domain having a value at a discrete frequency determined by the sampling frequency. Each complex multiplier in the complex multiplication unit 82 multiplies the complex signal in the frequency domain outputted from the discrete Fourier transform unit 81 by complex coefficients c0 to cN−1 computed by a coefficient computing unit, and a complex signal in the frequency domain whose waveform is equalized is obtained. The complex signal in the frequency domain whose waveform is equalized is outputted to the inverse discrete Fourier transform unit 83. The inverse discrete Fourier transform unit 83 performs inverse discrete Fourier transform to the inputted complex signal in the frequency domain, converts into the complex signal in the time domain and outputs the converted signal.

Here, the filter coefficient for compensating the chromatic dispersion can be computed by a wavelength of the optical carrier signal or a value of the chromatic dispersion. Where, the descriptions on a concerned numerical formula or the like are skipped.

The coefficient computing unit 84 computes each filter coefficient of c0 to cN−1 by the above-mentioned formula with an input of information on a wavelength and a chromatic dispersion value measured by measuring instruments or monitoring circuits. See, for example, the paragraph 0025 of the patent literature 2 disclosed a numerical formula 1.

Supposing that there are no analog waveform degradation factors, the filter coefficient used for the above described waveform equalization filter is computed.

According to the exemplary embodiment of the optical receiver, the analog waveform degradation factor inherent in the optical receiver is quantitatively measured at the time of inspections of manufacturing shipment of the optical receiver, and the filter coefficient for correcting the factor is determined separately.

An exemplary embodiment will be described with reference to the drawing.

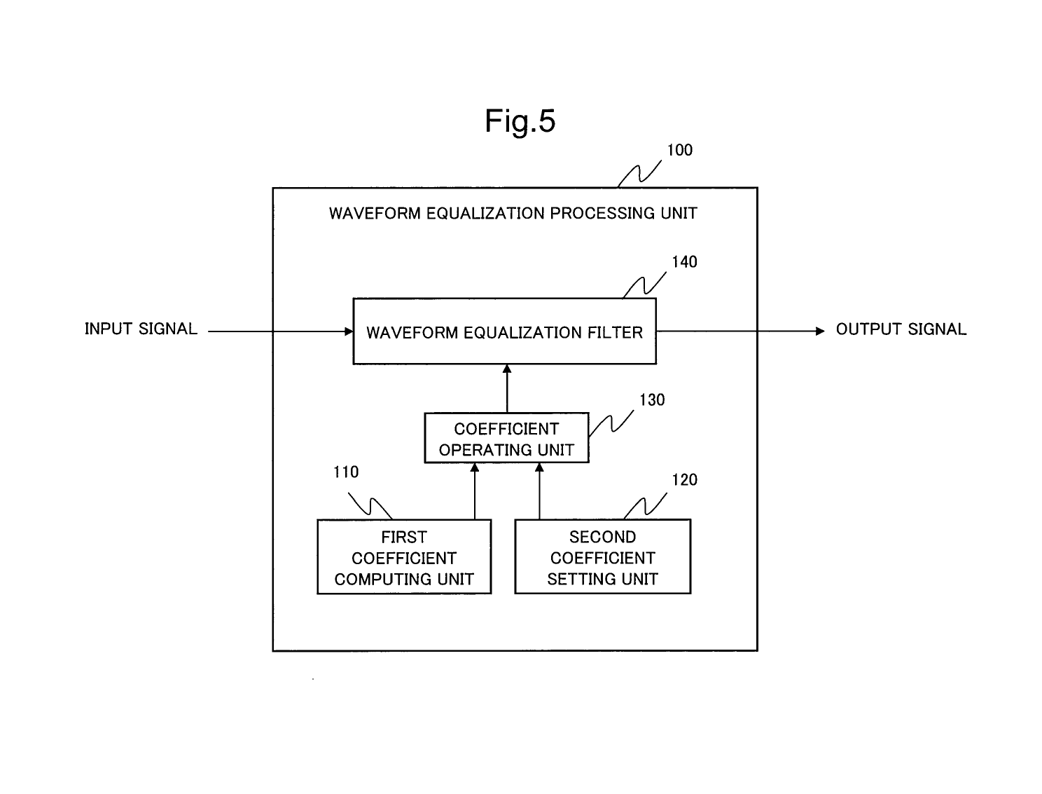

FIG. 5 is the block diagram showing a configuration of the waveform equalization processing unit included in the optical receiver according to the first exemplary embodiment of the present invention.

The exemplary embodiment is only for illustrations, and the disclosed devices and the systems are not limited to the configuration of the following exemplary embodiment.

The waveform equalization processing unit 100 includes the first coefficient computing unit 110, the second coefficient setting unit 120, a coefficient operating unit 130 and a waveform equalization filter 140.

The first coefficient computing unit computes the first equalization filter coefficient for compensating the first waveform distortion caused and formed when a optical signal is transmitted in an optical fiber transmission path. The second coefficient setting unit 120 predetermines the second equalization filter coefficient in advance for compensating the second waveform distortion caused and formed by the analog characteristics degradation of the optical receiver. The coefficient operating unit 130 performs operation on the first equalization filter coefficient and the second equalization filter coefficient, and outputs the third equalization filter coefficient. The waveform equalization filter 140 performs the equalization process to an input signal including the first waveform distortion and the second waveform distortion based on the third equalization filter coefficient, and outputs an output signal in which the first waveform distortion and the second waveform distortion are corrected respectively.

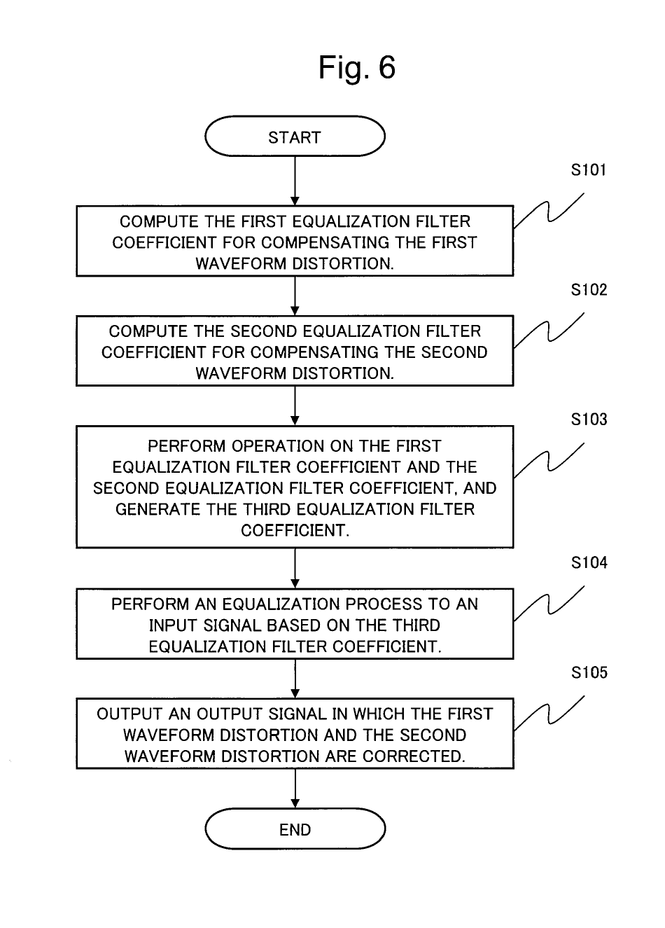

In addition, FIG. 6 is the flowchart showing a process of the waveform equalization processing unit included in the optical receiver according to the first exemplary embodiment of the present invention.

First, the first equalization filter coefficient for compensating the first waveform distortion of the optical signal caused and formed when the optical signal is transmitted in the optical fiber transmission path is computed (S101). Then, the predetermined second equalization filter coefficient for compensating the second waveform distortion caused and formed by the analog characteristics degradation of the optical receiver is obtained (S102). Then, operation is performed to the first equalization filter coefficient and the second equalization filter coefficient, and the third equalization filter coefficient is generated (S103). The equalization process to an input signal including the first waveform distortion and the second waveform distortion based on the third equalization filter coefficient is performed (S104). Output signal in which the first waveform distortion and the second waveform distortion are respectively corrected is outputted (S105).

As described above, the waveform equalization processing unit of the optical receiver according to the first exemplary embodiment includes the second coefficient setting unit in addition to the first coefficient computing unit which computes the first equalization filter coefficient for compensating the first waveform distortion caused and formed when the optical signal is transmitted in the optical fiber transmission path.

The second equalization filter coefficient for compensating the second waveform distortion caused and formed by the analog characteristics degradation of the optical receiver is predetermined in the second coefficient setting unit. For example, at first, an analog waveform degradation factor which the optical receiver has is quantitatively measured at the time of inspections of manufacturing shipment of the optical receiver. Then, the filter coefficient which corrects the factor is determined as the second equalization filter coefficient. In other words, characteristics of each component equipped in the optical receiver are measured, and the frequency/time filtering coefficients for compensating those degradation degrees are determined.

Then, operation on the first equalization filter coefficient and the second equalization filter coefficient are performed by a coefficient operating unit, and the third equalization filter coefficient is generated. The waveform equalization filter performs the equalization process to the input signal which includes the first waveform distortion and the second waveform distortion based on the third equalization filter coefficient, and outputs the output signal in which the first waveform distortion and the second waveform distortion are corrected respectively. Thus, the optical receiver according to the first exemplary embodiment can improve sensitivity degradation by digitally correcting the signal waveform distorted by the analog waveform degradation factor such as component fluctuations, at the waveform equalization processing unit equipped with the second coefficient setting unit and computing units.

In other words, according to the first exemplary embodiment, by digitally correcting the analog characteristics degradation by adding simple circuit configurations, the optical receiver in which the degradation of receiving sensitivity is improved can be realized.

Next, the second exemplary embodiment will be described.

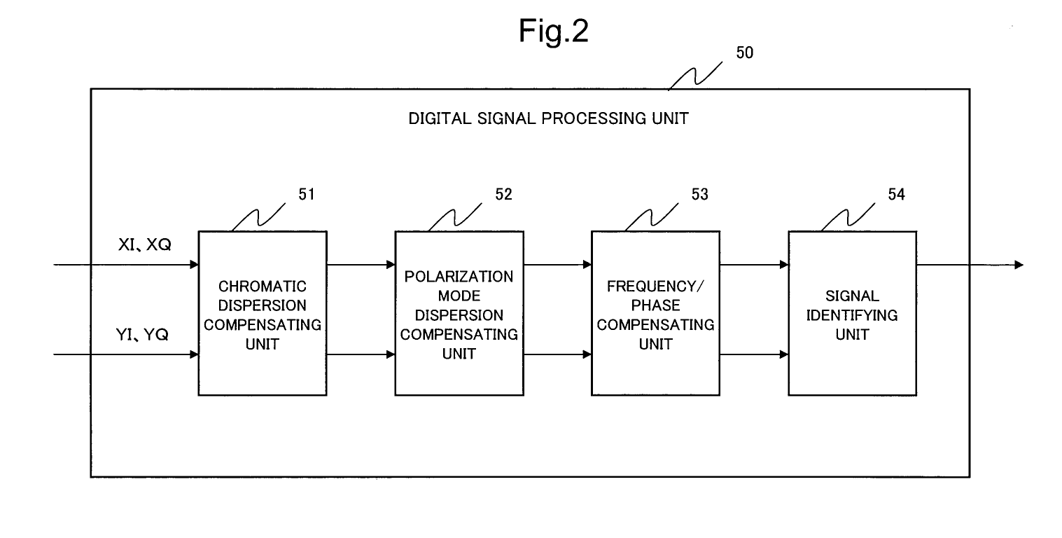

The waveform equalization processing unit included in the optical receiver according to the second exemplary embodiment is equivalent to the chromatic dispersion compensating unit 51 shown in FIG. 2, and the frequency domain waveform equalization filter is used as the waveform equalization filter. Where, the frequency domain waveform equalization filter includes a discrete Fourier transform unit, a complex multiplication unit and an inverse discrete Fourier transform unit which are shown in FIG. 4.

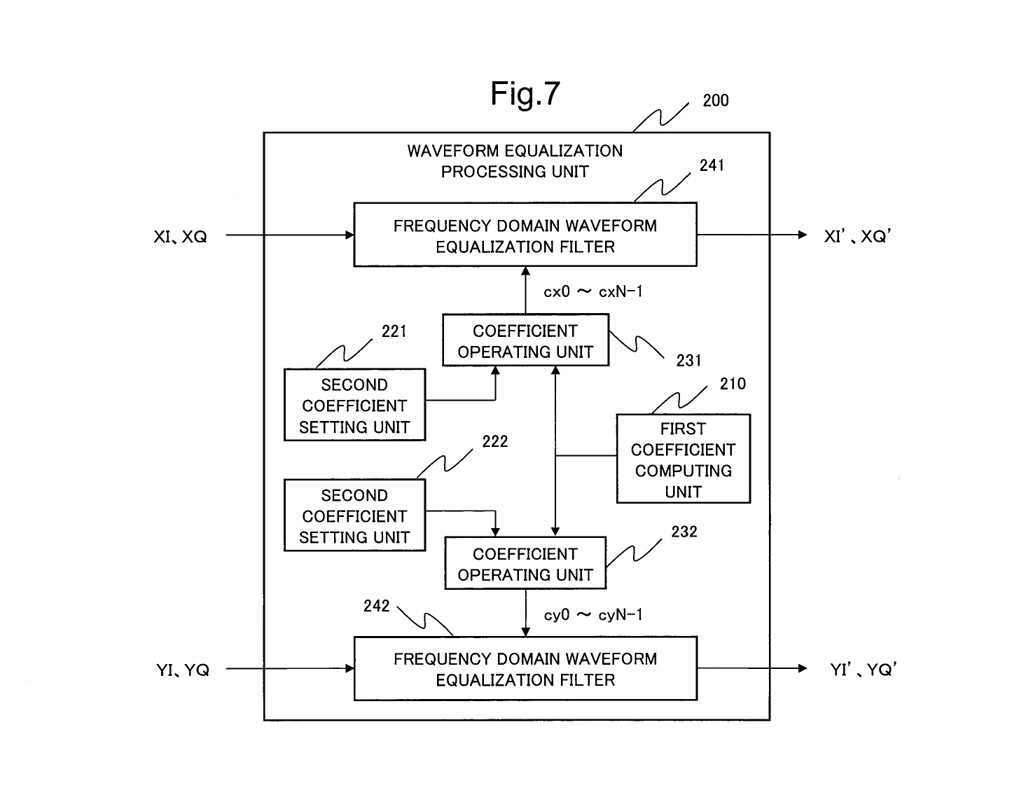

FIG. 7 is the block diagram showing the configuration of the waveform equalization processing unit included in the optical receiver according to the second exemplary embodiment of the present invention. In a waveform equalization processing unit 200, a filter coefficient calculated based on a coefficient for compensating the chromatic dispersion and a coefficient for improving the analog characteristics degradation is used. As the result, the waveform equalization processing unit 200 intends to compensate the chromatic dispersion and to improve the analog characteristics degradation using the same frequency domain waveform equalization filter.

The waveform equalization processing unit 200 includes frequency domain waveform equalization filters 241 to 242, a first coefficient computing unit 210, a second coefficient setting units 221 to 222 and coefficient operating units 231 to 232.

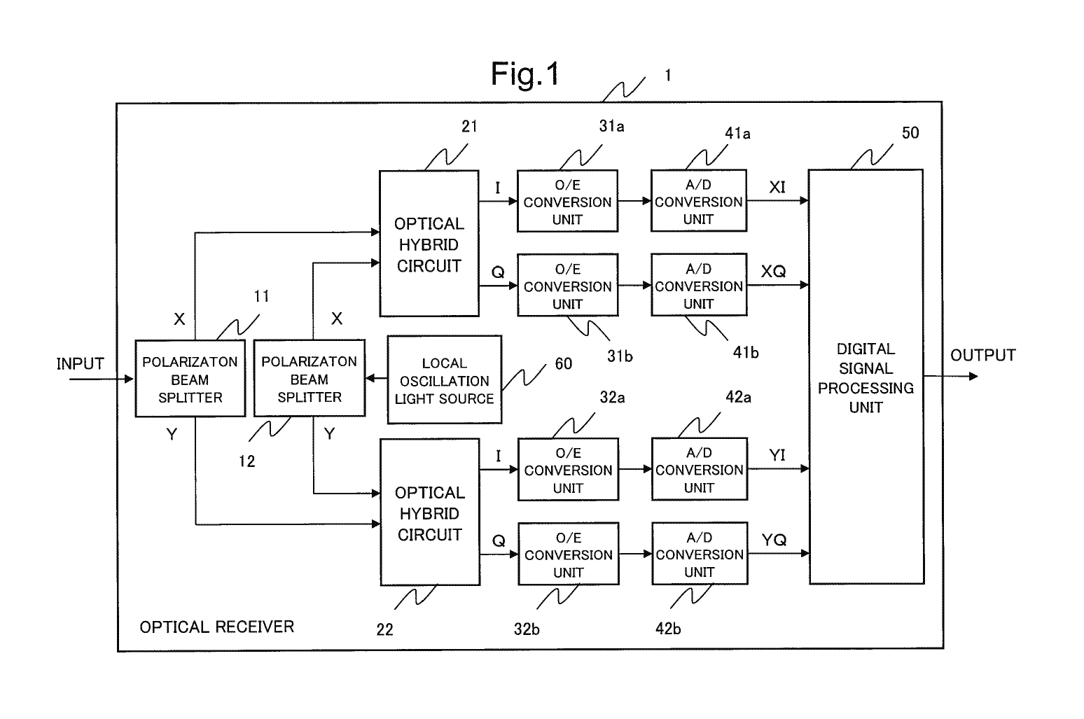

The digital signals including I-component of X polarization, Q-component of X polarization, I-component of Y polarization and Q-component of Y polarization outputted respectively from the A/D conversion units 41a, 41b, 42a and 42b shown in FIG. 1, are inputted to the waveform equalization processing unit 200.

For digital signal of each component, process for compensation of the chromatic dispersion and improvement of the analog characteristics degradation by the corresponding frequency domain waveform equalization filter is performed. The waveform equalization processing unit 200 shown in FIG. 7 includes the frequency domain waveform equalization filter 241 for X polarization process and the frequency domain waveform equalization filter 242 for Y polarization process. And, both of the frequency domain waveform equalization filters 241 and 242 include the frequency domain waveform equalization filters for I-components and for Q-components. Similarly, the second coefficient setting units 221 and 222 and the coefficient operating units 231 and 232 are provided in accordance with the frequency domain waveform equalization filter for I-components and for Q-components.

Because contents of process of a X polarization process and a Y polarization process are the same, a process of the waveform equalization processing unit 200 with reference to an example of configuration which includes the first coefficient computing unit 210, the second coefficient setting unit 221, the coefficient operating unit 231 and the frequency domain waveform equalization filter 241 is described.

The first coefficient computing unit 210 computes the frequency filter coefficient for compensating the chromatic dispersion based on information such as wavelength and chromatic dispersion value of the optical carrier signal, and outputs the frequency filter coefficient to the coefficient operating unit 231.

A coefficient for compensating the characteristics degradation is predetermined in the second coefficient setting unit 221 from an external device not illustrated. Here, the coefficient for compensating the characteristics degradation means a coefficient which compensates the analog characteristics degradation inhering in each component which configures the polarization beam splitter, the optical hybrid circuit, the O/E conversion unit and the A/D conversion unit of the optical receiver. For example, the characteristics of each components included in the optical receiver is quantitatively measured at the time of inspections of manufacturing shipment of the optical receiver, and the frequency filter coefficient for compensating those degradation degrees is set to the second coefficient setting unit 221 from an external device as the second equalization filter coefficient. Then, the second coefficient setting unit 221 outputs a predetermined frequency filter coefficient to the coefficient operating unit 231.

The frequency filter coefficient for compensating the chromatic dispersion and the frequency filter coefficient for compensating the analog characteristics degradation is inputted to the coefficient operating unit 231. Then, the coefficient operating unit 231 preforms operation such as complex multiplication based on those two kinds of frequency filter coefficients, and outputs filter coefficients cx0 to cxN−1 used in the frequency domain waveform equalization filter 241. In other words, the coefficient operating unit 231 performs operation such as complex multiplication for two kinds of coefficient which correspond to each discrete frequency component and outputs a filter coefficient used by the complex multiplication unit which configures the frequency domain waveform equalization filter 241. The coefficient operating unit 231 can perform the above-mentioned complex multiplication or a nonlinear operation (e.g. squared operation or Log operation) usually performed in the convolution operation or various conversion processes.

In the complex multiplication unit which configures the frequency domain waveform equalization filter 241, the frequency filter coefficient which has two characteristics including compensation of the chromatic dispersion and compensation of the analog characteristics degradation is complex-multiplied for each discrete frequency component of the inputted complex signal. Consequently, the optical receiver according to the second exemplary embodiment can simultaneously implement both compensation of the chromatic dispersion and compensation of the analog characteristics degradation caused by the component fluctuations in the waveform equalization processing unit 200.

In this way, the optical receiver according to the second exemplary embodiment digitally corrects the signal waveform distorted by the analog waveform degradation factors such as the component fluctuations in the waveform equalization processing units which have each of the second coefficient setting unit and the coefficient operating unit. Consequently, the optical receiver according to the second exemplary embodiment can improve the degradation of receiving sensitivity.

In other words, according to the second exemplary embodiment, by adding a simple circuit configuration and digitally correcting the analog characteristics degradation, the optical receiver in which the sensitivity degradation of the receiving signal is improved is realized.

Next, a variation example according to the second exemplary embodiment will be described.

The variation example according to the second exemplary embodiment includes the same configuration as the waveform equalization processing unit 200 according to the second exemplary embodiment described with reference to FIG. 7. The difference between the variation example and the second exemplary embodiment is on a point that, in this variation example, the plurality of frequency filter coefficients set as the second equalization filter coefficient are predetermined in the second coefficient setting units 221 and 222 from an external device. Then, a most suitable frequency filter coefficient is selected among the plurality of frequency filter coefficients and is used.

First, the frequency domain equalization filter coefficient having the frequency characteristics which should be corrected is acquired in advance from the design specifications of, such as, the polarization beam splitter, the optical hybrid circuit, the O/E conversion unit and the A/D conversion unit, or, the analog characteristics measured at the time of shipment from a plant. For example, the frequency characteristics for correcting the waveform distortion caused by the analog waveform degradation factor due to fluctuation of such as the component characteristics will be a characteristic which enhances a gain of high frequency component.

And, a plurality of frequency domain equalization filter coefficients having the frequency characteristics which should correct in accordance with a change in passage of time of the component degradation are prepared corresponding to the time course.

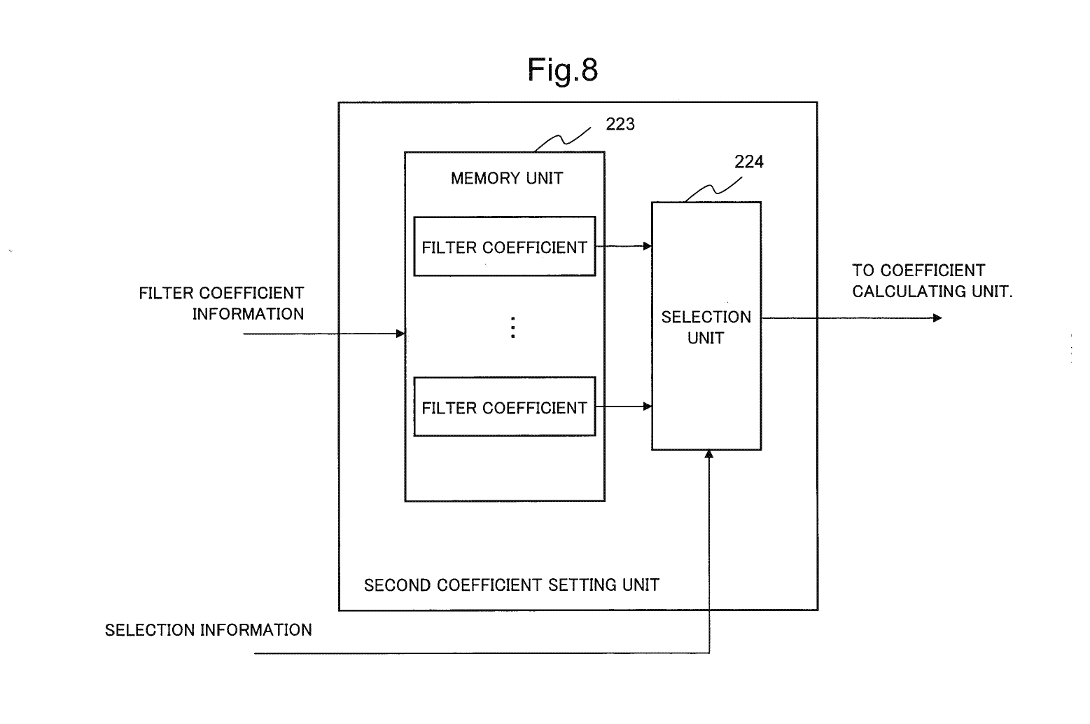

FIG. 8 is the block diagram showing the configuration of the second coefficient setting unit according to the variation example of the second exemplary embodiment.

The second coefficient setting unit according to the variation example includes a memory unit 223 in which the plurality of frequency domain equalization filter coefficients are set and memorized from an external device, and a selection unit 224 which selects one from the plurality of frequency domain equalization filter coefficients based on selection information from an external device.

In this case, the accumulated operation time of the optical receiver is measured by a time measuring means not illustrated, and it is designated by selection information from an external device which frequency domain equalization filter coefficient is used in accordance with the accumulated operation time. The selection unit 224 selects the designated frequency domain equalization filter coefficient from the memory unit 223 and outputs the selected frequency domain equalization filter coefficient to an operation unit 231.

Further, the second coefficient setting unit according to the variation example does not need to be the configuration as shown in FIG. 8. For example, the configuration that a plurality of frequency domain equalization filter coefficients can be memorized in a common unit of the optical receiver which includes the above-mentioned time measuring means, and a frequency domain equalization filter coefficient which should be used can be properly set to the second coefficient setting unit is allowed.

In addition, the plurality of frequency domain equalization filter coefficients can be configured in a different approach. For example, based on information on the fluctuation of characteristics which dependent on a production lot of the components equipped in the optical receiver, a plurality of the frequency domain equalization filter coefficients having the frequency characteristics which should correct the fluctuation in accordance with the characteristics can be prepared corresponding to the production lot of the component. In this case, the plurality of frequency domain equalization filter coefficients are memorized in the common unit of the optical receiver, and the frequency domain equalization filter coefficient which should be used is set to the second coefficient setting unit in advance based on information on the production lot of the components equipped in the optical receiver.

In this way, in the variation example, by preparing in advance the plurality of filter coefficients and a most suitable filter coefficient is selected and used in accordance with the situation of the optical receiver, the optical receiver which can efficiently correct the desired analog characteristics degradation is provided.

Next, the third exemplary embodiment will be described.

The waveform equalization processing unit included in the optical receiver according to the third exemplary embodiment is equivalent to the polarization mode dispersion compensating unit 52 shown in FIG. 2, and the time domain equalization filter is used as the waveform equalization filter. Here, the time domain equalization filter includes a delay unit, a multiplication unit and an addition unit which are shown in FIG. 3.

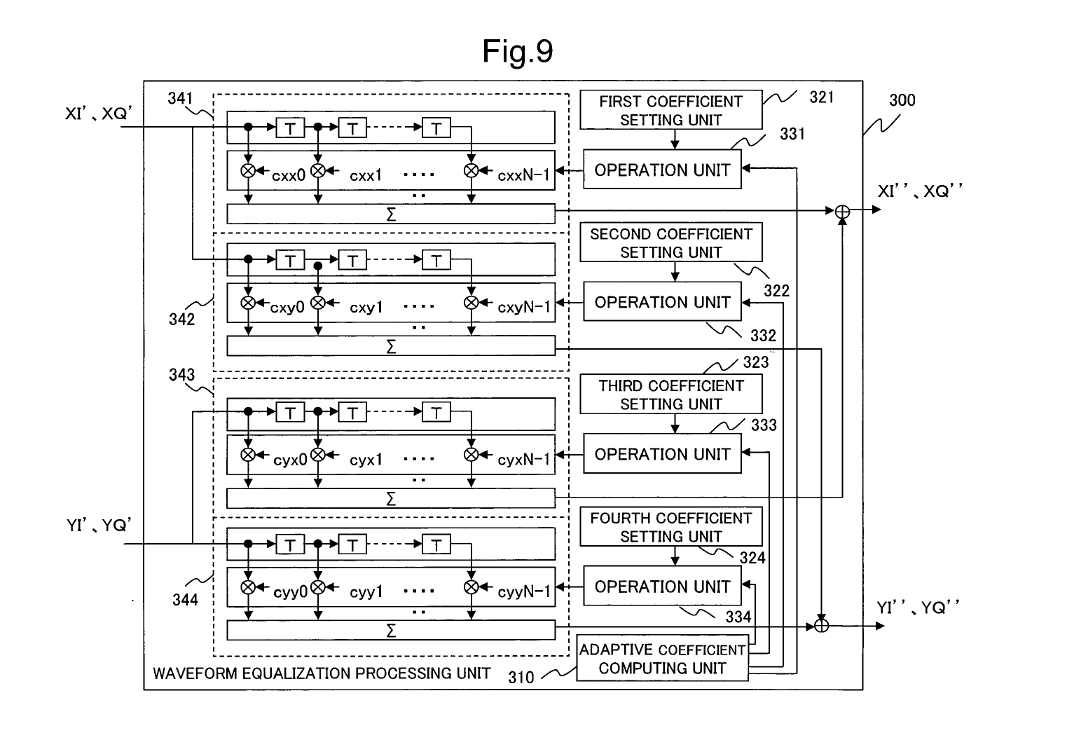

FIG. 9 is the block diagram showing the configuration of the waveform equalization processing unit included in the optical receiver according to the third exemplary embodiment of the present invention. By using the filter coefficient calculated based on a coefficient for compensating the polarization mode dispersion and a coefficient for improving the analog characteristics degradation, a waveform equalization processing unit 300 intends to improve the polarization mode dispersion compensation and the analog characteristics degradation using the same time domain equalization filter.

The waveform equalization processing unit 300 includes time domain equalization filters 341 to 344, an adaptive coefficient computing unit 310, the first coefficient setting unit 321, the second coefficient setting unit 322, the third coefficient setting unit 323, the fourth coefficient setting unit 324 and operation units 331 to 334.

The adaptive coefficient computing unit 310 monitors X polarization signal XI″ and XQ″, and Y polarization signal YI″ and YQ″ which are outputted from the waveform equalization processing unit 300, and adaptively computes the time domain equalization filter coefficient to the monitored result. In other words, by the coefficient computing algorithm such as CMA, the adaptive coefficient computing unit 310 computes the time domain equalization filter coefficient for compensating the polarization mode dispersion, and outputs the computed coefficient to the operation units 331 to 334.

The time domain equalization filter coefficient corresponding to each tap is predetermined respectively to the first coefficient setting unit 321 for X polarization, the second coefficient setting unit 322 for between X and Y polarization, the third coefficient setting unit 323 for between Y and X polarization and the fourth coefficient setting unit 324 for Y polarization. For example, in the first coefficient setting unit 321 which sets the coefficient for X polarization and the fourth coefficient setting unit 324 which sets the coefficient for Y polarization, the filter coefficient for correcting the frequency characteristics to each polarization component are set. Then, the filter coefficient for compensating an imperfectness of the polarization beam splitter and the optical hybrid circuit is set to the second coefficient setting unit 322 which sets the coefficient between X and Y polarization and the third coefficient setting unit 323 which sets the coefficient between Y and X polarization.

Where, the imperfectness means that, in the polarization beam splitter, because of fluctuation of design and manufacturing, a part of Y polarization component remains in the separated X polarization component and a part of X polarization component remains in the Y polarization component. In addition, in the optical hybrid circuit, the imperfectness means that, because of fluctuation of design and manufacturing, a part of Q-component remains in the separated I-component and a part of I-component remains in the separated Q-component. And, these kinds of imperfectness are measured at the time of inspections of manufacturing shipment by using a test means such as by inputting a test light. Based on the measured result, a coefficient for restoring the Y polarization component which remains in X polarization component to Y polarization component will be set as the filter coefficient.

Each of the first coefficient setting unit 321, the second coefficient setting unit 322, the third coefficient setting unit 323 and the fourth coefficient setting unit 324 outputs the determined time domain equalization filter coefficient to the corresponding operation units 331 to 334.

In addition, by the coefficient determined to each of the first coefficient setting unit 321, the second coefficient setting unit 322, the third coefficient setting unit 323 and the fourth coefficient setting unit 324, an appropriate initial value can be provided to the adaptive coefficient computing unit 310. In other words, an algorithm for determining an adaptive coefficient in the adaptive coefficient computing unit 310 is formed based on a presumption that there are no analog waveform degradation factors. In addition, in general, by setting an appropriate initial value, most algorithms for determining the coefficient can hasten the convergence to a coefficient which indicates a desired filter characteristic. Therefore, a state where there is no analog degradation for the adaptive coefficient computing unit 310 is generated by quantitatively measuring the analog waveform degradation factor which the optical receiver has at the time of inspections of manufacturing shipment and setting as the initial value of the filter coefficient for the correction. Consequently, the convergence of coefficient computing of the equalization filter can be hastened in the adaptive coefficient computing unit 310.

Each operation units 331 to 334 perform operation such as a complex multiplication based on the filter coefficient for compensating the polarization mode dispersion computed in the adaptive coefficient computing unit 310 and the above-mentioned filter coefficient set to the corresponding coefficient setting units 321 to 324. Consequently, the time domain equalization filter coefficient used by the corresponding time domain equalization filters 341 to 344 is computed and outputted to the respective multiplication unit in the time domain equalization filters 341 to 344. Where, an operation performed by the operation units 331 to 334 can be the above-mentioned complex multiplication, or can be a nonlinear operation (e.g. squared operation or Log operation) usually performed in a convolution operation or various conversion processes.

Coefficients cxx0 to cxxN−1 are outputted to the time domain equalization filter 341 and coefficients cxy0 to cxyN−1 are outputted to the time domain equalization filter 342. Further, coefficients cyx0 to cyxN−1 are outputted to the time domain equalization filter 343 and coefficients cyy0 to cyyN−1 are outputted to the time domain equalization filter 344.

In each of the multiplication unit in time domain equalization filters 341 to 344, the filter coefficient having two characteristics including compensation of the polarization mode dispersion and compensation of the analog characteristics degradation are performed complex multiplication for each tap component of the inputted complex signal. Consequently, the optical receiver according to the third exemplary embodiment can simultaneously implement by the waveform equalization processing unit 300 compensation of the polarization mode dispersion and compensation of the analog characteristics degradation caused by the component fluctuations.

Thus, the optical receiver according to the third exemplary embodiment can improve sensitivity degradation by digitally correcting the signal waveform distorted by the analog waveform degradation factor such as the component fluctuations by the waveform equalization processing unit having both the coefficient setting unit and the operation unit.

In other words, by adding a simple circuit configuration and digitally correcting the analog characteristics degradation, the third exemplary embodiment realizes an optical receiver whose degradation of receiving sensitivity is improved.

The variation example according to the third exemplary embodiment is configured similar to the variation example according to the second exemplary embodiment. In other words, in the variation example according to the third exemplary embodiment, the plurality of time domain equalization filter coefficients are predetermined to each one or one among the first coefficient setting unit 321, the second coefficient setting unit 322, the third coefficient setting unit 323 and the fourth coefficient setting unit 324. In this case, the coefficient which becomes an initial value for the frequency characteristics which should be corrected and for the adaptive computation is acquired in advance from the polarization beam splitter, the optical hybrid circuit, the design specification such as the O/E conversion unit and the A/D conversion unit or the analog characteristics measured at the time of shipment from a plant. Then, the time domain equalization filter coefficient which matches with the required condition is selected from the plurality of time domain equalization filter coefficients and is used.

Even in this variation example, an optical receiver which can efficiently correct the desired analog characteristics degradation is provided by selecting and using a most suitable filter coefficient in accordance with the situation of the optical receiver from a plurality of filter coefficients prepared in advance.

Next, the fourth exemplary embodiment is described.

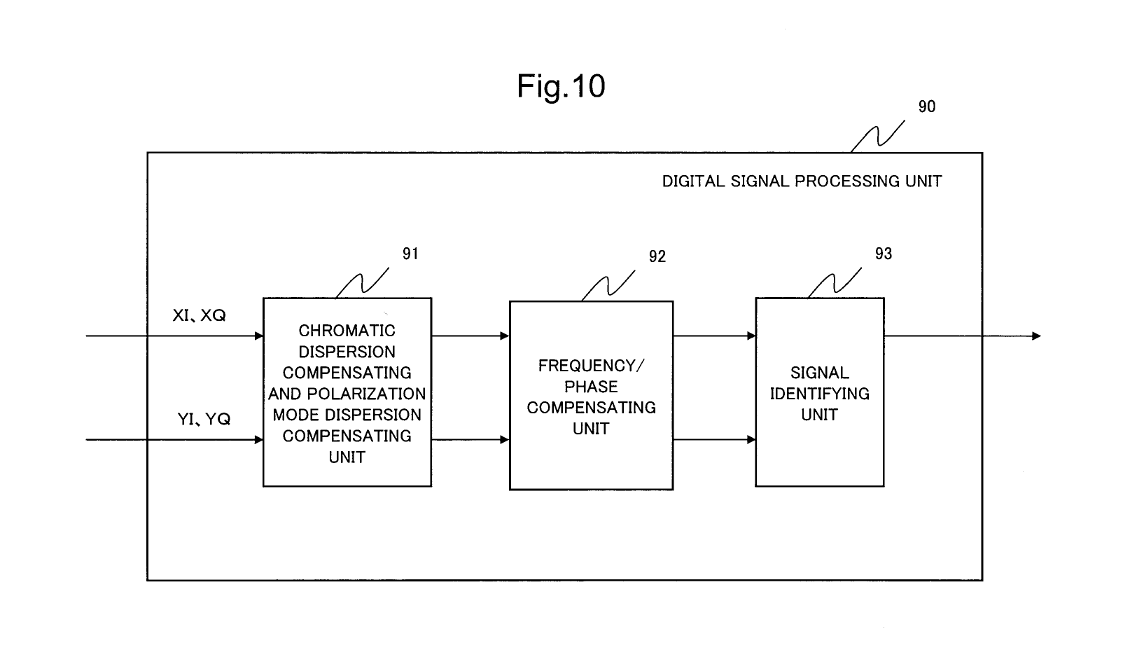

FIG. 10 is the block diagram showing the configuration of a digital signal processing unit 90 of the optical receiver according to the fourth exemplary embodiment of the present invention.

The difference from the digital signal processing unit 50 shown in FIG. 2 is on a point that the chromatic dispersion compensating unit 51 and the polarization mode dispersion compensating unit 52 shown in FIG. 2 are configured as single function block including a chromatic dispersion compensating/polarization mode dispersion compensating unit 91. Accordingly, a frequency/phase compensating unit 92 and a signal identifying unit 93 have the same configurations as the frequency/phase compensating unit 53 and the signal identifying unit 54 shown in FIG. 2.

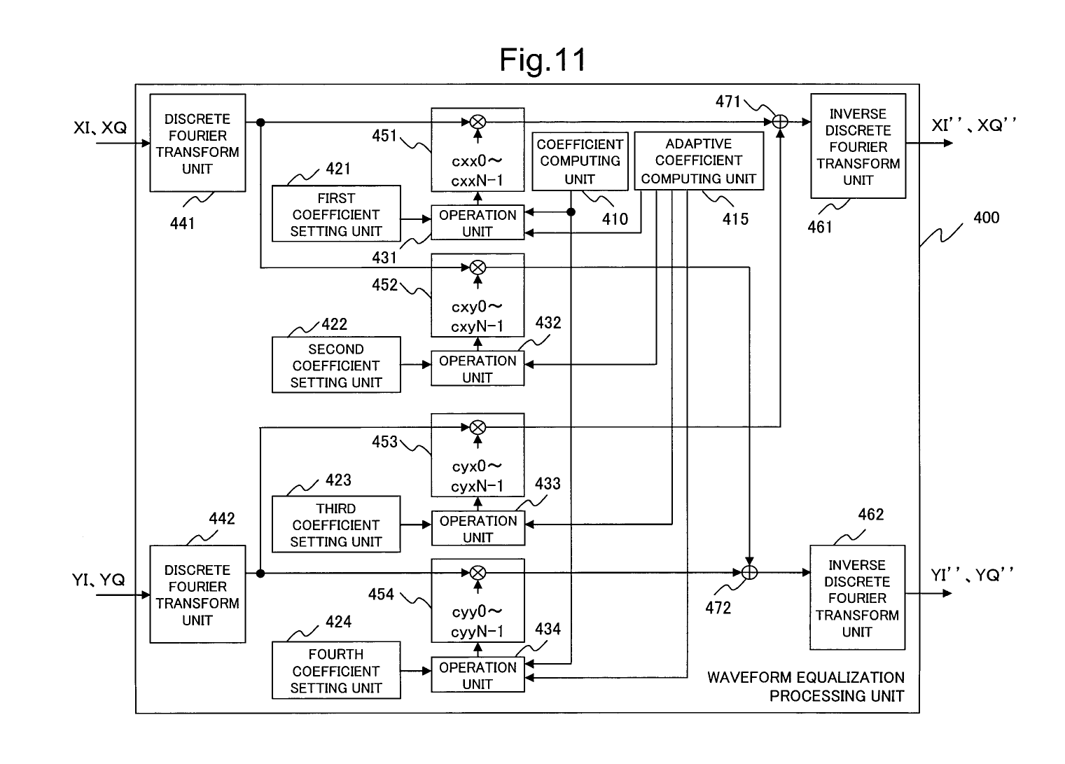

FIG. 11 is a block diagram showing the configuration of the waveform equalization processing unit which is the chromatic dispersion compensating/polarization mode dispersion compensating unit 91 included in the digital signal processing unit 90 of the optical receiver according to the fourth exemplary embodiment of the present invention.

A waveform equalization processing unit 400 uses a coefficient calculated based on the coefficient for compensating the chromatic dispersion, the coefficient for compensating the polarization mode dispersion and the coefficient for improving the analog characteristics degradation. Then, the waveform equalization processing unit 400 intends to improve the compensation of the chromatic dispersion, the polarization mode dispersion compensation and the analog characteristics degradation by using these coefficients. Where, the waveform equalization processing unit 400 configures the waveform equalization filter by the frequency domain waveform equalization filter. And, the waveform equalization processing unit 400 includes discrete Fourier transform units 441 to 442, complex multiplication units 451 to 454, complex addition adders 471 to 472 and inverse discrete Fourier transform units 461 to 462 as the waveform equalization filters. In addition, the waveform equalization processing unit 400 includes a coefficient computing unit 410, an adaptive coefficient computing unit 415, the first coefficient setting unit 421 to the fourth coefficient setting unit 424 and operation units 431 to 434.

The discrete Fourier transform units 441 and 442 perform discrete Fourier transform to the inputted complex signal and convert into the complex signal in the frequency domain. The complex multiplication units 451 to 454 multiply the complex signal in the frequency domain outputted from the discrete Fourier transform units 441 and 442 by the filter coefficient outputted from corresponding one among the operation units 431 to 434, and output the result to the complex adders 471 and 472. The complex adders 471 and 472 perform the complex addition of the complex signals inputted from the complex multiplication units 451 to 454 and output to the inverse discrete Fourier transform units 461 and 462. The inverse discrete Fourier transform units 461 and 462, performs inverse discrete Fourier transform to the inputted frequency domain complex signal and converts into the time domain complex signal, and outputs the converted signal.

The coefficient computing unit 410 computes the frequency domain equalization filter coefficient for compensating the chromatic dispersion based on information such as a wavelength of optical carrier and a value of the chromatic dispersion, and outputs the computed signal to the operation units 431 to 434.

The adaptive coefficient computing unit 415 is monitoring X polarization signals XI″ and XQ″, and Y polarization signals YI″ and YQ″ which are outputted from the waveform equalization processing unit 400, and computes the time domain equalization filter coefficient to the monitored results. In other words, by a coefficient computing algorithm such as CMA, the adaptive coefficient computing unit 415 computes the time domain equalization filter coefficient for compensating the polarization mode dispersion, and outputs computed signal to the operation units 431 to 434.

The time domain equalization filter coefficient is predetermined respectively to the first coefficient setting unit 421 for X polarization, the second coefficient setting unit 422 for between X and Y polarization, the third coefficient setting unit 423 for between Y and X polarization and the fourth coefficient setting unit 424 for Y polarization.

The contents of these coefficients are the same as those described in the third exemplary embodiment. In other words, in the first coefficient setting unit 421 which sets the coefficient for the X polarization and the fourth coefficient setting unit 424 which sets the coefficient for the Y polarization, the filter coefficient for correcting the frequency characteristics to each polarization component are set. Then, the filter coefficient for compensating an imperfectness of the polarization beam splitter and the optical hybrid circuit is set to the second coefficient setting unit 422 which sets the coefficient between X and Y polarization and to the third coefficient setting unit 423 which sets the coefficient between Y and X polarization.

In addition, following to the coefficient set to each of the first coefficient setting unit 421, the second coefficient setting unit 422, the third coefficient setting unit 423 and the fourth coefficient setting unit 424, an appropriate initial value can be provided to the adaptive coefficient computing unit 415 as is similar to the third exemplary embodiment. In other words, as described in the third exemplary embodiment, an algorithm of adaptive coefficient decision in the adaptive coefficient computing unit 415 is formed based on a presumption that there are no analog waveform degradation factors. In addition, in general, by setting an appropriate initial value, most algorithms for determining the coefficient can hasten the convergence to a coefficient indicating a desired filter characteristic. Therefore, by quantitatively measuring the analog waveform degradation factors which the optical receiver has at the time of inspections of manufacturing shipment and setting the filter coefficient for correcting these as the initial value, a state where there is no analog degradation to the adaptive coefficient computing unit 415 can be generated. Consequently, the convergence of coefficient computing of the equalization filter is hastened in the adaptive coefficient computing unit 415.

The operation units 431 to 434 perform operation such as complex multiplication based on the filtering coefficients outputted from the coefficient computing unit 410, the adaptive coefficient computing unit 415 and the corresponding coefficient setting units 421 to 424 respectively. In other words, the operation units 431 to 434 receive the filter coefficient for compensating the chromatic dispersion computed in the coefficient computing unit 410, the filter coefficient for compensating the polarization mode dispersion computed in the adaptive coefficient computing unit 415 and the filter coefficient set to the coefficient setting units 421 to 424. Then, the operation units 431 to 434 perform a complex multiplication or a nonlinear operation (e.g. squaring operation or Log operation) usually performed in a convolution operation or various conversion processes, and output the coefficient to be multiplied by the complex signal in the frequency domain to the corresponding complex multiplication units 451 to 454. As shown in FIG. 11, coefficients cxx0 to cxxN−1 are outputted to the complex multiplication unit 451 and coefficients cxy0 to cxyN−1 are outputted to the complex multiplication unit 452, as the coefficients to be multiplied by the complex signal in the frequency domain. Then, the coefficients cyx0 to cyxN−1 are outputted to the complex multiplication unit 453 and coefficients cyy0 to cyyN−1 are outputted to the complex multiplication unit 454.

In this way, according to the fourth exemplary embodiment, a result of an operation of the coefficients having three characteristics including compensation of the chromatic dispersion, compensation of the polarization mode dispersion and compensation of the analog characteristics degradation is defined as the frequency domain equalization filter coefficient in the waveform equalization processing unit 400. Therefore, according to the fourth exemplary embodiment, the waveform equalization processing unit 400 can simultaneously performs compensation of the chromatic dispersion, compensation of the polarization mode dispersion and compensation of the analog characteristics degradation.

In addition, according to the fourth exemplary embodiment, because a chromatic dispersion compensating unit and a polarization mode dispersion compensating unit are integrated, the number of circuits of the complex multiplier and the operation unit can be reduced.

Thus, by digitally correcting the signal waveform distorted by the analog waveform degradation factors such as the component fluctuations in the waveform equalization processing unit having the coefficient setting unit and the operation unit respectively, the optical receiver according to the fourth exemplary embodiment can improve sensitivity degradation.

In other words, according to the fourth exemplary embodiment, by digitally correcting the analog characteristics degradation through addition of a simple circuit configuration, an optical receiver, in which sensitivity degradation of the receiving signal is improved, is realized.

Incidentally, the variation example of the fourth exemplary embodiment similar to the variation example is also can be configured according to the second exemplary embodiment and the variation example according to the third exemplary embodiment. In other words, the plurality of time domain equalization filter coefficients can be predetermined to each one or one among the first coefficient setting unit 421, the second coefficient setting unit 422, the third coefficient setting unit 423 and the fourth coefficient setting unit 424. In this case, the coefficient which becomes an initial value for the frequency characteristics which should be corrected and for the adaptive computation is acquired in advance from the polarization beam splitter, the optical hybrid circuit, the design specification such as the O/E conversion unit and the A/D conversion unit or the analog characteristics measured at the time of shipment from a plant. Then, the equalization filter coefficient which matches with a required condition is selected among the plurality of the frequency domain filter coefficients and is used.

Accordingly, even in the variation example, the optical receiver which can efficiently correct the desired analog characteristics degradation can be provided by selecting and using a most suitable filter coefficient from the plurality of filter coefficients prepared in advance in accordance with the situation of the optical receiver.

As described by the plurality of exemplary embodiments and variation examples, for the optical receiver according to the exemplary embodiment of the present invention, the characteristics of each component equipped are measured at the time of inspections of manufacturing shipment or the like. Then, the frequency/time filtering coefficient for compensating the deteriorating degree of those characteristics is determined. Further, the optical receiver according to each exemplary embodiment calculates in advance the frequency/time filter coefficient and the filter coefficient for compensating the degradation factors of the transmission path such as the chromatic dispersion and the polarization mode dispersion, and applies a resultant filter coefficient after the operation to the waveform equalization filter for the receiving signal. In other words, by installing a circuit which predetermines the coefficient for compensating the degradation factors due to the analog characteristics in advance and a circuit which calculates a plurality of types of coefficient, the optical receiver can compensate degradation factors due to the analog characteristics along with the degradation factor of the chromatic dispersion and the polarization mode dispersion by the transmission path. Thus, in the optical receiver as configured like this, since not only the degradation factor by the transmission path but also the degradation factor due to the analog characteristics are compensated at the stage of the equalization of the receiving signal waveform, the degradation of receiving sensitivity can be improved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2011-020707, filed on Feb. 2, 2011, the disclosure of which is incorporated herein in its entirety by reference.

DESCRIPTION OF CODES

| | |
|---|---|
| 1 | Optical Receiver |
| 11 and 12 | Polarization Beam Splitter |
| 21 and 22 | Optical Hybrid Circuit |
| 31a, 31b, 32a and 32b | O/E Conversion Unit |
| 41a, 41b, 42a and 42b | A/D Conversion Unit |
| 50 and 90 | Digital Signal Processing Unit |
| 60 | Local Oscillation Light Source |
| 51 | Chromatic dispersion Compensating |
| | Unit |
| 52 | Polarization Mode Dispersion |
| | Compensating Unit |
| 53 and 92 | Frequency/Phase Compensating Unit |
| 54 and 93 | Signal Identifying Unit |
| 71 | Delay Unit |
| 72 | Multiplication Unit |
| 73 | Addition Unit |
| 81, 441 and 442 | Discrete Fourier Transform Unit |
| 82, 451, 452, 453 and 454 | Complex Multiplication Unit |
| 83, 461 and 462 | Inverse discrete Fourier Transform Unit |
| 84 and 410 | Coefficient Computing Unit |
| 91 | Chromatic dispersion Compensating |
| | and Polarization Mode Dispersion |
| | Compensating Unit |
| 100, 200, 300 and 400 | Waveform Equalization Processing Unit |
| 110 and 210 | First Coefficient Computing Unit |
| 120, 221 and 222 | Second Coefficient Setting Unit |
| 130, 231 and 232 | Coefficient operating unit |
| 140 | Waveform Equalization Filter |
| 223 | Memory Unit |
| 224 | Selection Unit |
| 241 and 242 | Frequency Domain Waveform |
| | Equalization Filter |
| 310 and 415 | Adaptive Coefficient Computing Unit |
| 321 and 421 | First Coefficient Setting Unit |
| 322 and 422 | Second Coefficient Setting Unit |
| 323 and 423 | Third Coefficient Setting Unit |
| 324 and 424 | Fourth Coefficient Setting Unit |
| 331, 332, 333 and 334 | Operation unit |
| 431, 432, 433 and 434 | Operation unit |
| 471 and 472 | Complex Adder |

1. An optical receiver comprising a waveform equalization processing unit, including:
a first coefficient computing unit that computes a first equalization filter coefficient for compensating a first waveform distortion caused and formed by transmission at a optical signal in an optical fiber transmission path;
a second coefficient setting unit that predetermines a second equalization filter coefficient for compensating a second waveform distortion caused and formed by an analog characteristics degradation of components which configure the optical receiver;
a coefficient operating unit that performs operation on said first equalization filter coefficient and said second equalization filter coefficient and outputs a third equalization filter coefficient; and
an waveform equalization filtering unit that performs an equalization process to an input signal including said first waveform distortion and said second waveform distortion based on said third equalization filter coefficient, corrects each of said first waveform distortion and said second waveform distortion, and outputs an output signal.

2. The optical receiver according to claim 1, wherein
said second coefficient setting unit
memorizes plurality of said second equalization filter coefficients in advance and selects one of said second equalization filter coefficient among memorized plurality of said second equalization filter coefficients and outputs said selected second equalization filter coefficient based on an instruction.

3. The optical receiver according to claim 1, wherein
said second coefficient setting unit memorizes in advance plurality of equalization filter coefficients corresponding to time course which coefficients compensate characteristics degradation of components configuring said optical receiver according to changes with passage of time, and selects one of said second equalization filter coefficient among memorized plurality of said second equalization filter coefficients and outputting said selected second equalization filter coefficient based on an instruction following to accumulated operation time of said optical receiver.

4. The optical receiver according to claim 1, wherein
said waveform equalization filtering unit is a frequency domain waveform equalization filter,
said first coefficient computing unit computes an equalization filter coefficient for compensating chromatic dispersion, and
said coefficient operating unit performs operation on said equalization filter coefficient for compensating chromatic dispersion and said second equalization filter coefficient, and outputs said third equalization filter coefficient.

5. The optical receiver according to claim 1, wherein
said waveform equalization filtering unit is a time domain equalization filter,
said first coefficient computing unit computes an equalization filter coefficient for compensating polarization mode dispersion, and
said coefficient operating unit performs operation on said equalization filter coefficient for compensating polarization mode dispersion and said second equalization filter coefficient, and outputs said third equalization filter coefficient.

6. The optical receiver according to claim 1, wherein
said waveform equalization filtering unit is a frequency domain waveform equalization filter,
said first coefficient computing unit includes a coefficient computing unit that computes an equalization filter coefficient for compensating chromatic dispersion and an adaptive coefficient computing unit that computes an equalization filter coefficient for compensating polarization mode dispersion, and
said coefficient operating unit performs operation on said equalization filter coefficient for compensating chromatic dispersion, said equalization filter coefficient for compensating polarization mode dispersion and said second equalization filter coefficient, and outputs said third equalization filter coefficient.

7. A method for optical reception, comprising:
computing a first equalization filter coefficient for compensating a first waveform distortion caused and formed by transmission of a optical signal in an optical fiber transmission path;
obtaining a predetermined second equalization filter coefficient for compensating a second waveform distortion caused and formed by an analog characteristics degradation of components which configure an optical receiver;
performing operation on said first equalization filter coefficient and said second equalization filter coefficient and generating a third equalization filter coefficient;
performing an equalization process to an input signal including said first waveform distortion and said second waveform distortion based on said third equalization filter coefficient; and
outputting an output signal in which each of said first waveform distortion and said second waveform distortion is corrected.

8. The method for optical reception according to claim 7, comprising:
memorizing plurality of said second equalization filter coefficients in advance; and
selecting one of said second equalization filter coefficient among memorized plurality of said second equalization filter coefficients and outputting said selected second equalization filter coefficient based on an instruction.

9. The method for optical reception according to claim 7, comprising:
memorizing in advance plurality of equalization filter coefficients corresponding to time course which coefficients compensate characteristics degradation of components configuring said optical receiver according to changes with passage of time; and
selecting one said second equalization filter coefficient among memorized plurality of said second equalization filter coefficients and outputting said selected second equalization filter coefficient based on an instruction following to accumulated operation time of said optical receiver.

10. An optical receiver comprising waveform equalization processing means, including:
first coefficient computing means for computing a first equalization filter coefficient for compensating a first waveform distortion caused and formed by transmission at a optical signal in an optical fiber transmission path;
second coefficient setting means for predetermining a second equalization filter coefficient for compensating a second waveform distortion caused and formed by an analog characteristics degradation of components which configure the optical receiver;
coefficient operating means for performing operation on said first equalization filter coefficient and said second equalization filter coefficient and outputting a third equalization filter coefficient; and
waveform equalization filtering means for performing an equalization process to an input signal including said first waveform distortion and said second waveform distortion based on said third equalization filter coefficient, correcting each of said first waveform distortion and said second waveform distortion, and outputting an output signal.
